(19) United States
(12) Patent Application Publication
(10) Pub. No.: US 2021/0379604 A1
(43) Pub. Date: Dec. 9, 2021

(54) NOVEL METHOD FOR THE FLOTATION OF BASTNAESITE ORE

(71) Applicant: Arizona Board of Regents on Behalf of the University of Arizona, Tucson, AZ (US)

(72) Inventors: Jinhong Zhang, Tucson, AZ (US); Dongbo An, Tucson, AZ (US)

(21) Appl. No.: 17/342,109

(22) Filed: Jun. 8, 2021

Related U.S. Application Data
(60) Provisional application No. 63/036,410, filed on Jun. 8, 2020.

(51) Int. Cl. B03D 1/02; B03D 1/01; B03D 1/008; B03D 1/002

(52) U.S. Cl. CPC B03D 1/02; B03D 1/01; B03D 1/008; B03D 2201/04; B03D 2201/06; B03D 2201/02; B03D 2203/02; B03D 1/002

(57) ABSTRACT

A method is provided for using flotation techniques for separating rare earth metal compounds from bastnaesite ore. The method can include grinding the ore to obtain an aqueous slurry of particles, adding a depressant agent to the slurry and adjusting the pH to a suitable value for the flotation process, adding a collector mixture to the slurry that includes at least one hydroxamic acid, and adding a frother agent to the slurry, followed by subjecting the slurry to froth flotation.

### CROSS-REFERENCE TO RELATED APPLICATIONS

This application claims the benefit of U.S. Provisional Appl. No. 63/036,410, filed Jun. 8, 2020. The content of the foregoing application is relied upon and is incorporated by reference herein in its entirety.

### STATEMENT OF FEDERALLY SPONSORED RESEARCH AND DEVELOPMENT

This invention was made with government support under Grant No. N00014-15-C-0165 awarded by NAVY/ONR. The government has certain rights in this invention.

### FIELD OF THE INVENTION

The field of the invention relates generally to extraction of metal compounds from ores.

### BACKGROUND

Rare earth metals are important to the fields of electronics, chemical industry, metallurgy, machinery, energy, and the like, and are strategic raw materials for developing new technologies.

Bastnaesite is a source of carbonate rare earth element minerals. Besides the cerium group of elements (Ce, La, Pr, Nd), bastnaesite also contains yttrium (Y(CO₃)F) and europium. Some bastnaesite contains hydroxyl instead of F, such as hydroxylbastnaesite-(Ce) and hydroxylbastnaesite-(Nd). Cerium is the primary light rare earth element in most natural bastnaesite. Therefore, bastnaesite-(Ce) is a more accurate expression for bastnaesite study in most cases. Typically, it contains 65-75% rare earth oxides. Bastnaesite is usually found in pegmatites, carbonatite and hydrothermal ore bodies in alkaline gangue minerals. Bastnaesite occurs as veins or dissemination in a complex of carbonate-silicate rocks, occurring with and related to alkaline intrusive, for example, in California.

The separation of rare earth metals from crude ore has typically relied on a flotation separation process, based on hydrophobicity differences, and relies on use of a “collector agent” that selectively associates with the target mineral(s). The selection of a collector agent or mixture of agents plays an important role in bastnaesite flotation. The choice of collector is made based on the properties of ores, such as flotation response of rare earth minerals and gangue minerals. Traditional flotation methods involve use of carboxylic acids (e.g., oleic acid, phthalic acid, oxidized paraffin) as the collectors. Unfortunately, when carboxylic acid collectors are used, cost can become an issue, decreasing the profits of the mine. It is therefore of great importance to introduce a simpler, more environmentally friendly and more cost-efficient flotation scheme using other collectors.

### SUMMARY

The inventors surprisingly developed a robust, cost effective process for separating rare earth metal compounds from crude ores, such as bastnaesite ore, which include rare earth metal compounds (including, for example, cerium, lanthanum, praseodymium, neodymium, and yttrium).

In one aspect, a method is provided for using flotation techniques for separating rare earth metal compounds from bastnaesite ore. The method can include grinding the ore to obtain an aqueous slurry of particles, adding a depressant agent to the slurry and adjusting the pH to a suitable value for the flotation process, adding a collector mixture to the slurry that includes at least one hydroxamic acid, and adding a frother agent to the slurry, followed by subjecting the slurry to froth flotation.

### DETAILED DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not specifically referred to.

As used herein, the term “collector oil” refers to hydrocarbon oil, such as, but not limited to, diesel oil, kerosene. The term “collector oil” as used herein includes collector oils such as diesel oil, kerosene, a copper/molybdenum collector (which may be derived from an organosulfur hydrocarbon and heavy hydrocarbon, which is non-selective to all sulfides; e.g., ORFOM® MCO Collector, also known as “MCO”).

As used herein, the term “P80” refers to the 80% passing size obtained by a sieve size analysis of an ore grinding product. P80 is a well-known term in the mining arts. It is used to refer to the “average” particle size of a sample. i.e. about 40 to about 80 microns In some aspects of the invention, the P80 value used may be in a range from about 45 to about 75 microns, or even about 60 microns, or about 74 microns.

The term “alkyl hydroxamic acid” includes C₅-C10-alkyl hydroxamic acids.

Froth Flotation

Froth flotation is one of the most important and economical extraction methods in mineral processing industry. Flotation has been widely applied in the extraction of various types of mineral sulfides, phosphates, oxides, and semi-soluble salts. The separation efficiency of flotation is usually characterized by the recovery and the grade of the target mineral, which depend greatly on the flotation parameters, such as particle size, collector's type and dosage, depressant, and temperature.

Flotation separation is an important process for the recovery of rare earth minerals from low grade ore. The process is based on differences in the surface hydrophobicity of different components. The flotation process typically includes grinding the ore to liberate mineral particles, treating the mineral particles with a depressant agent to render undesired particles hydrophilic, and a collector agent to render the desired particles hydrophobic. A frothing agent is then added to enhance flotation of the more hydrophobic particles, whereby they become selectively concentrated in the froth. The froth can then be conveyed away from undesired particles for further processing.

Collectors

The collector agent plays an important role in bastnaesite flotation. The choice of collector is made based on the properties of ores, such as flotation response of rare earth minerals and gangue minerals. Traditional flotation methods involve use of carboxylic acids (e.g., oleic acid, phthalic acid, oxidized paraffin) as the collectors. Unfortunately, when carboxylic acid collectors are used, cost can become an issue, decreasing the profits of the mine. It is therefore of great importance to introduce a simpler, more environmentally friendly and more cost-efficient flotation scheme using other collectors.

Alternatives for collectors include hydroxamic acids, which are a feature of the present disclosure. A collector mixture can further include a collector oil, which can be, for example, kerosene, diesel oil, and proprietary oils such as the copper/molybdenum collector derived from an organosulfur hydrocarbon and heavy hydrocarbons (e.g., ORFOM® MCO Collector, which according to the supplier is non-selective to all sulfides).

Depressants and Conditioners

A successful flotation practice requires more than the collectors. Depressants and conditioners are of great significance in flotation process, especially for rare earth minerals, which are often found associated with gangue minerals (impurities) either of high floatability or high similarity in flotation behavior. The selection of depressant and conditioner is mostly affected by gangue minerals, although the target rare earth minerals and collector agents also matter. A combination of all the reagents contributes to the separation of bastnaesite from gangue minerals.

The choice of collectors, depressant and conditioners impacts how environmentally friendliest and more cost-efficiency flotation scheme. The inventors have surprisingly discovered floatation conditions that result in an improved froth floatation process that is environmentally friendly and cost-effective.

In one aspect, the invention encompasses a method for flotation separation of rare earth metal compounds from bastnaesite ore comprising:
a) Crushing the bastnaesite ore,
b) Grinding the crushed ore in the presence of water (e.g., at ambient or elevated temperatures, for example 20° C. to 80° C.) to obtain an aqueous slurry with particles with (e.g., a P80 (80% passing size of about 40 to about 80 microns). In some cases, a maximum temperature of about 60° C. gives good results.
c) Adding depressant and pH conditioner to the aqueous slurry with particles. Depressants may include, for example, sodium silicate, potassium silicate, sodium sulfate, carboxymethyl cellulose (CMC), and combinations of those materials. The pH conditioner may include, for example, sodium hydroxide, potassium hydroxide, sodium carbonate, potassium carbonate, and the like, and combinations of those materials. A pH value that may be used for the flotation separation includes, for example, a value in the range of about 8 to about 10.
d) Adding a collector mixture to the slurry of step (c). Collectors may be used include, for example, a hydroxamic acid component, for example, salicylhydroxamic acid, benzohydroxamic acid, and alkyl hydroxamic acid(s) (e.g., R—C(O)NH—OH, where R is C5 to C10 alkyl), and combinations of these. In addition to a hydroxamic acid component, the collector mixture may include a collector oil, for example diesel oil, kerosene, a copper/molybdenum collector derived from an organosulfur hydrocarbon and heavy hydrocarbons (e.g., ORFOM® MCO Collector, which according to the supplier is non-selective to all sulfides). Amounts of various components in collector mixture may be adjusted to aid in selective recovery of rare earth metal compounds.
e) Adding a frother agent to the slurry from step (d). Frothers used in the methods disclosed herein may include, for example, methyl isobutyl carbinol (MIBC), polypropylene glycol, and combinations of those materials.
f) Subjecting the slurry containing the frother to froth flotation wherein the rare earth metal compounds are selectively concentrated in the froth.

In some embodiments, the method of the invention encompasses reaction conditions that involves the use of one or more collectors, one or more depressants, one or more frothers, and one or more pH conditioners chosen from the Table 1 (in the amounts and at the pH listed below):

TABLE 1

| Reagent | | lower | | upper |
|---|---|---|---|---|
| Type | Reagent Name | limit | optimum | limit |
| Collector | Salicylhydroxamic Acid | about 0.8 | about 1.6 | about 2.4 |
| | (kg/metric ton) | | | |
| | Alkyl hydroxamic Acid | about 0.01 | about 0.02 | about |
| | (kg/metric ton) | | | 0.05 |
| | Benzohydroxamic Acid | about 0.4 | about 0.8 | about 1.6 |
| | (kg/metric ton) | | | |
| | Collector oil (e.g., diesel | about 0.05 | about 0.1 | about 0.2 |
| | oil, kerosene, or MCO) | | | |
| | (kg/metric ton) | | | |
| De- | Potassium Silicate or | about 0.5 | about 1 | about 2 |
| pressant | Sodium Silicate (kg/metric | | | |
| | ton) | | | |
| | Sodium Sulfate (kg/metric | about 1 | about 2 | about 5 |
| | ton) | | | |
| | carboxymethyl cellulose | about 0.01 | about 0.02 | about |
| | (CMC) or dextrin or | | | 0.05 |
| | starch (kg/metric ton) | | | |
| Frother | e.g., methyl isobutyl | about 0.05 | about 0.1 | about 0.2 |
| | carbinol (MIBC) or | | | |
| | polypropylene glycol | | | |
| | (kg/metric ton) | | | |
| pH | sodium hydroxide or | about | about 9 | about 9.5 |
| Con- | potassium hydroxide and | 8 5 (pH) | (pH) | (pH) |
| ditioner | sodium carbonate or | (step (c)) | (step (c)) | (step (c)) |
| | potassium carbonate | | | |

In further embodiments, the invention encompasses a method:

wherein said collector comprises salicylhydroxamic acid and collector oil and optionally one or more collectors chosen from alkyl hydroxamic acid and benzohydroxamic acid;

wherein said depressants comprises potassium silicate or sodium silicate and optionally one or more depressants chosen from sodium sulfate, potassium sulfate and carboxymethyl cellulose (CMC) or dextrin or starch;

wherein said frother is methyl isobutyl carbinol or a propylene glycol;

wherein the pH of step (c) occurs at a pH between 8-10; and

wherein said amounts of collectors, depressants and frothers, and pH conditioners is as listed preceding table (Table 1).

In some embodiments the method of the invention involves one or more collectors, one or more depressants and one or more frothers, and pH conditioners, chosen from Table 2 (in the amounts and at the temperature and pH listed below):

TABLE 2

| Reagent Name | lower limit | optimum | upper limit |
|---|---|---|---|
| Salicylhydroxamic Acid | about 0.8 | about 1.6 | about 2.4 |
| (kg/metric ton) | | | |
| Collector oil (e.g., MCO) | about 0.05 | about 0.1 | about 0.2 |
| (kg/metric ton) | | | |
| Sodium Silicate | about 0.5 | about 1 | about 2 |
| (kg/metric ton) | | | |
| MIBC ( kg/metric ton) | about 0.05 | about 0.1 | about 0.2 |
| NaOH | about 8.5 (pH) | about 9 (pH) | about 9.5 (pH) |
| Temperature (° C.) | ambient | about 40 | about 60 |
| P80 (μm) | about 45 | about 60 | about 74 |

In some embodiments the method of the invention involves one or more collectors, one or more depressants and one or more frothers, and pH conditioners, chosen from Table 3 (in the amounts and at the temperature and pH listed below):

TABLE 3

| Reagent Type | Reagent Name | Dosage |
|---|---|---|
| Collector | Salicylhydroxamic Acid (kg/metric ton) | about 0.8 |
| | Alkyl hydroxamic Acid (kg/metric ton) | 0 |
| | Benzohydroxamic Acid ( kg/metric ton) | about 0.8 |
| | Collector oil ( e.g., MCO) ( kg/metric | about 0.1 |
| | ton) | |
| Depressant | Sodium Silicate (kg/metric ton) | about 1 |
| | Sodium Sulfate (kg/metric ton) | 0 |
| | CMC (kg/metric ton) | 0 |
| Frother | e.g., MIBC (kg/metric ton) | about 0.1 |
| pH Conditioner | NaOH | about 9 |
| | | (pH) |
| Temperature (° C.) | / | about 40 |
| P80 (μm) | / | about 45 |

In some embodiments the method of the invention involves one or more collectors, one or more depressants and one or more frothers, and pH conditioners, chosen from Table 4 (in the amounts and at the temperature and pH listed below):

TABLE 4

| Reagent Type | Reagent Name | Dosage |
|---|---|---|
| Collector | Salicylhydroxamic Acid ( kg/metric ton) | about 0.8 |
| | Alkyl hydroxamic Acid (kg/metric ton) | 0 |
| | Benzohydroxamic Acid ( kg/metric ton) | about 0.8 |
| | Collector oil (e.g., MCO) (kg/metric ton) | about 0.1 |
| Depressant | Sodium Silicate (kg/metric ton) | about 1 |
| | Sodium Sulfate (kg/metric ton) | about 2 |
| | CMC (kg/metric ton) | about 0.02 |
| Frother | MIBC (kg/metric ton) | about 0.1 |
| pH Conditioner | NaOH | about 9 |
| | | (pH) |
| Temperature (° C.) | / | about 60 |
| P80 (μm) | / | about 45 |

In some embodiments the method of the invention involves one or more collectors, one or more depressants and one or more frothers, and pH conditioners, chosen from Table 5 table (in the amounts and at the temperature and pH listed below):

TABLE 5

| Reagent Type | Reagent Name | Dosage |
|---|---|---|
| Collector | Salicylhydroxamic Acid | about 1.6 |
| | (kg/metric ton) | |
| | Alkyl hydroxamic Acid (kg/metric ton) | about 0.01 |
| | Benzohydroxamic Acid ( kg/metric ton) | 0 |
| | Collector oil (e.g., MCO) (kg/metric ton) | about 0.1 |
| Depressant | Sodium Silicate (kg/metric ton) | about 1 |
| | Sodium Sulfate (kg/metric ton) | 0 |
| | CMC (kg/metric ton) | 0 |
| Frother | MIBC (kg/metric ton) | about 0.1 |
| pH Conditioner | NaOH | about 9 |
| | | (pH) |
| Temperature (° C.) | / | about 40 |
| P80 (um) | / | about 45 |

In some embodiments the method of the invention involves one or more collectors, one or more depressants and one or more frothers, and pH conditioners, chosen from Table 6 (in the amounts and at the temperature and pH listed below):

TABLE 6

| Reagent Type | Reagent Name | Dosage |
|---|---|---|
| Collector | Salicylhydroxamic Acid (kg/metric ton) | about 1.6 |
| | Alkyl hydroxamic Acid (kg/metric ton) | 0 |
| | Benzohydroxamic Acid (kg/metric ton) | 0 |
| | Collector oil (e.g., MCO) (kg/metric ton) | about 0.1 |
| Depressant | Sodium Silicate (kg/metric ton) | about 1 |
| | Sodium Sulfate (kg/metric ton) | 0 |
| | CMC (kg/metric ton) | 0 |
| Frother | MIBC (kg/metric ton) | about 0.1 |
| pH Conditioner | NaOH | about 9 |
| | | (pH) |
| Temperature (° C.) | / | about 40 |
| P80 (um) | / | about 45 |

In some embodiments the method of the invention involves one or more collectors, one or more depressants and one or more frothers, and pH conditioners, chosen from Table 7 (in the amounts and at the temperature and pH listed below):

TABLE 7

| Reagent Type | Reagent Name | Dosage |
|---|---|---|
| Collector | Salicylhydroxamic Acid (kg/metric ton) | about 1.6 |
| | Alkyl hydroxamic Acid (kg/metric ton) | 0 |
| | Benzohydroxamic Acid (kg/metric ton) | 0 |
| | Collector oil (e.g., MCO) (kg/metric ton) | 0.1 |
| Depressant | Sodium Silicate (kg/metric ton) | 1 |
| | Sodium Sulfate (kg/metric ton) | 0 |
| | CMC (kg/metric ton) | 0 |
| Frother | MIBC (kg/metric ton) | 0.1 |
| pH Conditioner | NaOH | about 9 |
| | | (pH) |
| Temperature (° C.) | / | about 40 |
| P80 (um) | / | about 74 |

In some embodiments the method of the invention involves one or more collectors, one or more depressants and one or more frothers, and pH conditioners, chosen from Table 8 (in the amounts and at the temperature and pH listed below):

TABLE 8

| Reagent Type | Reagent Name | Dosage |
|---|---|---|
| Collector | Salicylhydroxamic Acid (kg/metric ton) | about 1.6 |
| | Alkyl hydroxamic Acid (kg/metric ton) | 0 |
| | Benzohydroxamic Acid (kg/metric ton) | 0 |
| | Collector oil (e.g., MCO) (kg/metric ton) | about 0.1 |
| Depressant | Sodium Silicate (kg/metric ton) | about 1 |
| | Sodium Sulfate (kg/metric ton) | 0 |
| | CMC (kg/metric ton) | 0 |
| Frother | MIBC ( kg/metric ton) | about 0.1 |
| pH Conditioner | NaOH | about 9 |
| | | (pH) |
| Temperature (° C.) | / | about 60 |
| P80 (um) | / | about 45 |

In some embodiments, the flotation method of the invention may involve the use of one or more of the following hydroxamic acid collectors listed in Table 9:

TABLE 9

| Name | Formula | Structure |
|---|---|---|
| C₈ Alkyl hydroxamic acid | C₇H₁₅CONHOH | 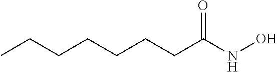 |
| C₆ Cycloalkyl hydroxamic acid | C₅H₁₃CONHOH | 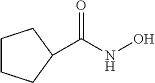 |
| Benzohydroxamic acid | C₆H₅CONHOH | 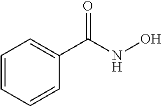 |
| Salicyldroxamic acid | HOC₆H₄CONHOH | 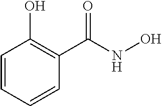 [SMILES: O=C(NO)c1ccccc1O] |
| 2-hydroxy-3-naphthylhydroximic acid(H₂₀₅) | OHC₁₀H₆CONHOH | 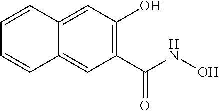 [SMILES: O=C(NO)c1cc2ccccc2cc1O] |

In further embodiments, the invention encompasses a method:

wherein said collector comprises salicylhydroxamic acid and collector oil and optionally one or more collectors chosen from alkyl hydroxamic acid and benzohydroxamic acid;

wherein said depressants comprises potassium silicate or sodium silicate and optionally one or more depressants chosen from sodium sulfate, potassium sulfate and carboxymethyl cellulose (CMC) or dextrin or starch;

wherein said frother is methyl isobutyl carbinol or a propylene glycol;

wherein the pH of step (c) occurs at a pH between 8-10; and

wherein said amounts of collectors, depressants and frothers, and pH conditioners is as listed any of the preceding tables (i.e., Tables 1-8).

### LIST OF EMBODIMENTS

In some aspects, the invention may also pertain to any of the following embodiments:
1. A method of flotation separation of rare earth metal compounds from bastnaesite ore, the method comprising the steps of:
   (a) crushing the bastnaesite ore;
   (b) grinding the crushed ore in the presence of water to obtain an aqueous slurry with particles of crushed ore;
   (c) adding depressant and pH conditioner to the slurry wherein the depressant comprises sodium silicate and/or potassium silicate and/or sodium sulfate; wherein the pH conditioner comprises sodium hydroxide and/or potassium hydroxide;
   (d) adding to the slurry of step (c) a collector mixture comprising:
      i) salicylhydroxamic acid and/or benzylhydroxamic acid and/or an alkyl hydroxamic acid; and
      ii) a collector oil;
   (e) adding to the slurry of step (d) a frother comprising methyl isobutyl carbinol and/or propylene glycol; and
   (f) subjecting the slurry of step (e) containing the frother to froth flotation, wherein the rare earth metal compounds are selectively concentrated in the froth.
2. The method of embodiment 1, wherein:
   the depressant comprises:
      sodium silicate in an amount of about 0.5 to 2.0 kg/metric ton of ore,
      sodium sulfate in an amount of about 1 to about 5 kg/metric ton of ore, and
      carboxymethyl cellulose in an amount of about 0.01 to about 0.05 kg/metric ton of ore;
   the pH conditioner is added in an amount sufficient to give the slurry of step (c) a pH of about 8.5 to about 9.5;
   the collector mixture comprises:
      i) salicylhydroxamic acid in an amount of about 0.8 to about 2.4 kg/metric ton of ore, benzohydroxamic acid in an amount of about 0[.] to about 1.6 kg/metric ton of ore, and alkyl hydroxamic acid in an amount of about 0[0.01] to about 0.05 kg/metric ton of ore; and
      ii) a collector oil in an amount of about 0.05 to about 0.2 kg/metric ton of ore; and
   the frother comprises methyl isobutyl carbinol and/or propylene glycol.in a total amount of about 0.05 to about 0.2 kg/metric ton of ore;
   wherein the P80 value is in a range from about 45 to about 75 microns, or even about 60 microns, or about 74 microns; and
   wherein step (b) is carried out a temperature in a range from ambient temperature or about 40° C., or about 60° C., about 20° C. to about 60° C., or even from about 40° C. to about 60° C.
3. The method of embodiment 1, wherein:
   the depressant comprises sodium silicate in amount of about 0.5 to about 2 kg/metric ton of ore;
   the pH conditioner is added in an amount sufficient to give the slurry of step (c) a pH of about 8.5 to about 9.5;
   the collector mixture comprises:
      i) salicylhydroxamic acid in an amount of about 0.8 to about 2.4 kg/metric ton of ore;
      ii) collector oil in an amount of about 0.05 to about 0.2 kg/metric ton of ore;
   the frother comprises methyl isobutyl carbinol and/or propylene glycol, to give a total amount of frother in range of about 0.05 to about 0.2 kg/metric ton of ore;
   the P80 value is in a range from about 45 to about 75 microns; and
   wherein step (b) is carried out a temperature in a range from about 40° C. to about 60° C.
4. The method of embodiment 1, wherein step (b) is carried out a temperature in a range from ambient temperature, or about 40° C., or about 60° C., about 20° C. to about 60° C., or about 20 to about 30° C., or even from about 40° C. to about 60° C.
5. The method of embodiment 1, where step (b) is carried out at a temperature between about 20-60° C.
6. The method of embodiment 1, wherein:
   the depressant comprises sodium silicate in amount of 0 about 2 kg/metric ton of ore, 0.5 to about 2 kg/metric ton of ore, or even about 1 to 2 kg/metric ton of ore, or about 1 kg/metric ton of ore;
   the pH conditioner is added in an amount sufficient to give the slurry of step (c) a pH of about 9.0;
   the collector mixture comprises:
   i) salicylhydroxamic acid in an amount of about 0.8 kg/metric ton of ore and benzohydroxamic acid in an amount of 0.8 kg/metric ton of ore; and
   ii) collector oil in an amount of about 0.1 kg/metric ton of ore;
   the frother comprises methyl isobutyl carbinol in an amount of about 0.1 kg/metric ton of ore;
   the P80 value is about 45 microns; and
   wherein step (b) is carried out a temperature of about 40° C.
7. The method of embodiment 1, wherein:
   the depressant comprises:
      sodium silicate in an amount of about 1 kg/metric ton of ore,
      sodium sulfate in an amount of about 2 kg/metric ton of ore, and
      carboxymethyl cellulose in an amount of about 0.02 kg/metric ton of ore;
   the pH conditioner is added in an amount sufficient to give the slurry of step (c) a pH of about 9;
   the collector mixture comprises:
      i) salicylhydroxamic acid in an amount of about 0.8 kg/metric ton of ore and benzohydroxamic acid in an amount of about 0.8 kg/metric ton of ore; and
      ii) a collector oil in an amount of about 0.1 kg/metric ton of ore;
   the frother comprises methyl isobutyl carbinol in an amount of about 0.1 kg/metric ton of ore;
   the P80 value is about 45 microns; and
   wherein step (b) is carried out a temperature of about 60° C.
8. The method of embodiment 1, wherein:
   the depressant comprises:
      sodium silicate in an amount of about 1 kg/metric ton of ore;
   the pH conditioner is added in an amount sufficient to give the slurry of step (c) a pH of about 9;
   the collector mixture comprises:
      i) salicylhydroxamic acid in an amount of about 1.6 kg/metric ton of ore and alkyl hydroxamic acid in an amount of about 0.01 kg/metric ton of ore; and
      ii) a collector oil in an amount of about 0.1 kg/metric ton of ore; and
   the frother comprises methyl isobutyl carbinol in an amount of about 0.1 kg/metric ton of ore;
   the P80 value is about 45 microns; and
   wherein step (b) is carried out a temperature of about 40° C.
9. The method of embodiment 1, wherein:
   the depressant comprises:
      sodium silicate in an amount of about 1 kg/metric ton of ore;
   the pH conditioner is added in an amount sufficient to give the slurry of step (c) a pH of about 9;
   the collector mixture comprises:
      i) salicylhydroxamic acid in an amount of about 1.6 kg/metric ton of ore; and
      ii) a collector oil in an amount of about 0.1 kg/metric ton of ore;
   the frother comprises methyl isobutyl carbinol in an amount of about 0.1 kg/metric ton of ore;
   the P80 value is about 45 microns; and
   wherein step (b) is carried out a temperature of about 40° C.
10. The method of embodiment 1, wherein:
   the depressant comprises:
      sodium silicate in an amount of about 1 kg/metric ton of ore;
   the pH conditioner is added in an amount sufficient to give the slurry of step (c) a pH of about 9;
   the collector mixture comprises:
      i) salicylhydroxamic acid in an amount of about 1.6 kg/metric ton of ore; and
      ii) a collector oil in an amount of about 0.1 kg/metric ton of ore;
   the frother comprises methyl isobutyl carbinol in an amount of about 0.1 kg/metric ton of ore;
   the P80 value is about 75 microns; and
   wherein step (b) is carried out a temperature of about 40° C.
11. The method of embodiment 1, wherein:
   the depressant comprises:
      sodium silicate in an amount of about 1 kg/metric ton of ore;
   the pH conditioner is added in an amount sufficient to give the slurry of step (c) a pH of about 9;
   the collector mixture comprises:
      i) salicylhydroxamic acid in an amount of about 1.6 kg/metric ton of ore; and
      ii) a collector oil in an amount of about 0.1 kg/metric ton of ore;
   the frother comprises methyl isobutyl carbinol in an amount of about 0.1 kg/metric ton of ore;
   the P80 value is about 45 microns; and
   wherein step (b) is carried out a temperature of about 60° C.
12. The method of any embodiments 1-11, wherein the pH of the slurry of step (c) is between about 8 to about 10.
13. The method of any of embodiment 1-12, wherein said depressant of step (c) further comprises carboxymethyl cellulose or dextrin or starch, or a combination thereof
14. The method of any of embodiments 1-13, wherein said collector mixture of step (d) is alkyl hydroxamic acid and/or benzohydroxamic acid.
15. The method of any of embodiment 1-14, wherein said pH conditioner of step (c) further comprises sodium carbonate and/or potassium carbonate.
16. Embodiment 16 is a method of flotation separation of rare earth metal compounds from bastnaesite ore comprising the steps of:
   (a) grinding crushed ore in the presence of water to obtain an aqueous slurry with particles of crushed ore;
   (b) adding depressant and pH conditioner to the slurry wherein the depressant comprises sodium silicate and/or potassium silicate and/or sodium sulfate;
      wherein the pH conditioner comprises sodium hydroxide and/or potassium hydroxide;
   (c) adding to the slurry of step (b) a collector mixture comprising:
      i) salicylhydroxamic acid and/or benzylhydroxamic acid and/or an alkyl hydroxamic acid; and
      ii) a collector oil;
   (d) adding to the slurry of step (c) a frother comprising:
      at least one of methyl isobutyl carbinol and/or propylene glycol; and
   (e) subjecting the slurry of step (d) containing the frother to froth flotation,
      wherein the rare earth metal compounds are selectively concentrated in the froth.
17. The method of embodiments 1-16, wherein said particles have a P80 value of about 40 microns to about 80 microns.
18. The method of any of embodiments 1-17, wherein the rare earth metal compounds comprise any of: cerium, lanthanum, praseodymium, neodymium, yttrium.
19. The method of embodiments 1 and 16, wherein the particles in the aqueous slurry of particles have a P80 size in a range of about 20 to about 80 microns, about 20 to about 75 microns, about 25 to about 75 microns, about 25 to about 70 microns, about 30 to 70 microns, about 30 to about 65 microns, about 35 to about 65 microns, about 35 to about 60 microns, about 40 to about 60 microns, about 45 to about 60 microns, about 45 to about 50 microns, about 45 to 75 microns, or even about 54 microns, or about 60 microns, or about 75 microns.
20. The method of embodiments 1-19, wherein the depressant can include: potassium silicate and/or sodium silicate in an amount of from about 0.5 to about 2 kg/metric ton of ore, or even about 1 kg/metric ton of ore; sodium sulfate in an amount of about 1 to about 5 kg/metric ton of ore; carboxymethyl cellulose (CMC) and/or dextran and/or starch in an amount of from about 0.01 kg/metric ton to about 0.05 kg/metric ton of ore; and any combination of these materials.
21. The method of embodiments 1-20, wherein the pH conditioner can include sodium hydroxide, sodium carbonate, potassium carbonate, and the like, and any combination of these materials, to provide a pH of the aqueous slurry of particles. The pH value can be in a range of from about 6 to about 10, from about 6 to about 9, from 6 to about 8, or even about 6, about 7, about 8, about 8.5, about 9, about 9.5.
22. The method of embodiments 1-21, wherein the collector mixture can include: salicylhydroxamic acid in an amount of from about 0.5 to about 3 kg/metric ton of ore, benzohydroxamic acid in an amount of from about 0.1 to about 2 kg/metric ton of ore; alkylhydroxamic acid (where alkyl is C5 to C10) in an amount of from about 0.01 to about 0.1 kg/metric ton of ore, or about 0.02 kg/metric ton of ore; and any combination of those hydroxamic acid materials. The collector mixture can further include a collector oil, including diesel oil, kerosene, a copper/molybdenum collector derived from an organosulfur hydrocarbon and heavy hydrocarbons (e.g., ORFOM® MCO Collector, which according to the supplier is non-selective to all sulfides), and any combination of those collector oil materials, in an amount of from about 0.05 to about 0.5 kg/metric ton of ore or about 0.1 kg/metric ton of ore.
23. The method of any of embodiments 1-22, wherein the frother comprises methyl isobutyl carbinol, polypropylene glycol, and combinations of those materials, in a total amount of from about 0.05 to about 0.5 kg/metric ton of ore, or about 0.1 kg/metric ton of ore.
24. The method of any of embodiments 1-22, wherein the P80 value is in a range from about 45 to about 75 microns, or even about 60 microns, or about 74 microns; and
25. wherein step (b) is carried out a temperature in a range from ambient temperature or about 40° C., or about 60° C., about 20° C. to about 60° C., or even from about 40° C. to about 60° C.
26.

### REFERENCES

Any patents and publication cited above are included to more fully describe and disclose the invention and the state of the art to which the invention pertains. All publications mentioned herein are incorporated by reference to the extent that they support the present invention.

We claim:

1. A method of flotation separation of rare earth metal compounds from bastnaesite ore comprising the steps of:
(a) crushing the bastnaesite ore;
(b) grinding the crushed ore in the presence of water to obtain an aqueous slurry with particles of crushed ore;
(c) adding depressant and pH conditioner to the slurry wherein the depressant comprises sodium silicate and/or potassium silicate and/or sodium sulfate;
wherein the pH conditioner comprises sodium hydroxide and/or potassium hydroxide;
(d) adding to the slurry of step (c) a collector mixture comprising:
i) salicylhydroxamic acid and/or benzylhydroxamic acid and/or an alkyl hydroxamic acid; and
ii) a collector oil;
(e) adding to the slurry of step (d) a frother comprising methyl isobutyl carbinol and/or propylene glycol; and
(f) subjecting the slurry of step (e) containing the frother to froth flotation,
wherein the rare earth metal compounds are selectively concentrated in the froth.

2. The method of claim 1, wherein:
the depressant comprises:
sodium silicate in an amount of about 0.5 to about 2.0 kg/metric ton of ore,
sodium sulfate in an amount of about 1 to about 5 kg/metric ton of ore, and
carboxymethyl cellulose in an amount of about 0.01 to about 0.05 kg/metric ton of ore;
the pH conditioner is added in an amount sufficient to give the slurry of step (c) a pH of about 8.5 to about 9.5;
the collector mixture comprises:
i) salicylhydroxamic acid in an amount of about 0.8 to about 2.4 kg/metric ton of ore, benzohydroxamic acid in an amount of about 0[0.4] to about 1.6 kg/metric ton of ore, and alkyl hydroxamic acid in an amount of about 0[0.01] to about 0.05 kg/metric ton of ore; and
ii) a collector oil in an amount of about 0.05 to about 0.2 kg/metric ton of ore; and
the frother comprises methyl isobutyl carbinol and/or propylene glycol.in a total amount of about 0.05 to about 0.2 kg/metric ton of ore.

3. The method of claim 1, wherein:
the depressant comprises sodium silicate in amount of about 0.5 to about 2 kg/metric ton of ore;
the pH conditioner is added in an amount sufficient to give the slurry of step (c) a pH of about 8.5 to about 9.5;
the collector mixture comprises:
i) salicylhydroxamic acid in an amount of about 0.8 to about 2.4 kg/metric ton of ore;
ii) collector oil in an amount of about 0.05 to about 0.2 kg/metric ton of ore;
the frother comprises methyl isobutyl carbinol and/or propylene glycol, to give a total amount of frother in range of about 0.05 to about 0.2 kg/metric ton of ore;
the P80 value is in a range from about 45 to about 75 microns; and
wherein step (b) is carried out a temperature in a range from about 40° C. to about 60° C.

4. The method of claim 1, where step (b) is carried out at a temperature between about 20 to about 30° C.

5. The method of claim 1, where step (b) is carried out at a temperature between about 20 to about 60° C.

6. The method of claim 1, wherein:
the depressant comprises sodium silicate in amount of about 0.5 to about 2 kg/metric ton of ore, or about 1 to about 2 kg/metric ton of ore, or 1 kg/metric ton of ore;
the pH conditioner is added in an amount sufficient to give the slurry of step (c) a pH of about 9.0;
the collector mixture comprises:
i) salicylhydroxamic acid in an amount of about 0.8 kg/metric ton of ore and benzohydroxamic acid in an amount of 0.8 kg/metric ton of ore; and
ii) collector oil in an amount of about 0.1 kg/metric ton of ore;
the frother comprises methyl isobutyl carbinol in an amount of about 0.1 kg/metric ton of ore;
the P80 value is about 45 microns; and
wherein step (b) is carried out a temperature of about 40° C.

7. The method of claim 1, wherein:
the depressant comprises:
sodium silicate in an amount of about 1 kg/metric ton of ore,
sodium sulfate in an amount of about 2 kg/metric ton of ore, and
carboxymethyl cellulose in an amount of about 0.02 kg/metric ton of ore;
the pH conditioner is added in an amount sufficient to give the slurry of step (c) a pH of about 9;
the collector mixture comprises:
i) salicylhydroxamic acid in an amount of about 0.8 kg/metric ton of ore and benzohydroxamic acid in an amount of about 0.8 kg/metric ton of ore; and
ii) a collector oil in an amount of about 0.1 kg/metric ton of ore;
the frother comprises methyl isobutyl carbinol in an amount of about 0.1 kg/metric ton of ore;
the P80 value is about 45 microns; and
wherein step (b) is carried out a temperature of about 60° C.

8. The method of claim 1, wherein:
the depressant comprises:
sodium silicate in an amount of about 1 kg/metric ton of ore;
the pH conditioner is added in an amount sufficient to give the slurry of step (c) a pH of about 9;
the collector mixture comprises:
i) salicylhydroxamic acid in an amount of about 1.6 kg/metric ton of ore and alkyl hydroxamic acid in an amount of about 0.01 kg/metric ton of ore; and
ii) a collector oil in an amount of about 0.1 kg/metric ton of ore; and
the frother comprises methyl isobutyl carbinol in an amount of about 0.1 kg/metric ton of ore;
the P80 value is about 45 microns; and
wherein step (b) is carried out a temperature of about 40° C.

9. The method of claim 1, wherein:
the depressant comprises:
sodium silicate in an amount of about 1 kg/metric ton of ore;
the pH conditioner is added in an amount sufficient to give the slurry of step (c) a pH of about 9;
the collector mixture comprises:
i) salicylhydroxamic acid in an amount of about 1.6 kg/metric ton of ore; and
ii) a collector oil in an amount of about 0.1 kg/metric ton of ore;
the frother comprises methyl isobutyl carbinol in an amount of about 0.1 kg/metric ton of ore;
the P80 value is about 45 microns; and
wherein step (b) is carried out a temperature of about 40° C.

10. The method of claim 1, wherein:
the depressant comprises:
sodium silicate in an amount of about 1 kg/metric ton of ore;
the pH conditioner is added in an amount sufficient to give the slurry of step (c) a pH of about 9;
the collector mixture comprises:
i) salicylhydroxamic acid in an amount of about 1.6 kg/metric ton of ore; and
ii) a collector oil in an amount of about 0.1 kg/metric ton of ore;
the frother comprises methyl isobutyl carbinol in an amount of about 0.1 kg/metric ton of ore;
the P80 value is about 75 microns; and
wherein step (b) is carried out a temperature of about 40° C.

11. The method of claim 1, wherein:
the depressant comprises:
sodium silicate in an amount of about 1 kg/metric ton of ore;
the pH conditioner is added in an amount sufficient to give the slurry of step (c) a pH of about 9;
the collector mixture comprises:
i) salicylhydroxamic acid in an amount of about 1.6 kg/metric ton of ore; and
ii) a collector oil in an amount of about 0.1 kg/metric ton of ore;
the frother comprises methyl isobutyl carbinol in an amount of about 0.1 kg/metric ton of ore;
the P80 value is about 45 microns; and
wherein step (b) is carried out a temperature of about 60° C.

12. The method of claim 1, wherein the pH of the slurry of step (c) is between about 8 to about 10.

13. The method of claim 1, wherein said depressant of step (c) further comprises carboxymethyl cellulose or dextrin or starch, or a combination thereof.

14. The method of claim 1, wherein said collector mixture of step (d) is alkyl hydroxamic acid and/or benzohydroxamic acid.

15. The method of claim 1, wherein said pH conditioner of step (c) further comprises sodium carbonate and/or potassium carbonate.

16. A method of flotation separation of rare earth metal compounds from bastnaesite ore comprising the steps of:
(a) grinding crushed bastnaesite ore in the presence of water to obtain an aqueous slurry with particles of crushed ore;
(b) adding depressant and pH conditioner to the slurry wherein the depressant comprises sodium silicate and/or potassium silicate and/or sodium sulfate;
wherein the pH conditioner comprises sodium hydroxide and/or potassium hydroxide;
(c) adding to the slurry of step (b) a collector mixture comprising:
i) salicylhydroxamic acid and/or benzylhydroxamic acid and/or an alkyl hydroxamic acid; and
ii) a collector oil;
(d) adding to the slurry of step (c) a frother comprising:
at least one of methyl isobutyl carbinol and/or propylene glycol; and
(e) subjecting the slurry of step (d) containing the frother to froth flotation,
wherein the rare earth metal compounds are selectively concentrated in the froth.

17. The method of claim 1, wherein said particles have a P80 value of about 40 microns to about 80 microns.

18. The method of claim 1, wherein the rare earth metal compounds comprise any of the chosen from cerium, lanthanum, praseodymium, neodymium, and yttrium.
